(19) United States
(12) Patent Application Publication
(10) Pub. No.: US 2023/0069019 A1
(43) Pub. Date: Mar. 2, 2023

(54) REALITY MODEL OBJECT RECOGNITION USING CROSS-SECTIONS

(71) Applicant: SKYYFISH LLC, Stevensville, MT (US)

(72) Inventor: Orest Jacob Pilskalns, Missoula, MT (US)

(21) Appl. No.: 17/887,436

(22) Filed: Aug. 13, 2022

Related U.S. Application Data
(60) Provisional application No. 63/233,047, filed on Aug. 13, 2021.

(51) Int. Cl. G06T 7/50; G01B 11/25

(52) U.S. Cl. CPC G06T 7/50; G01B 11/2545

(57) ABSTRACT

A reality-based model object recognition system using cross-sections includes using photogrammetry to obtain various views of a 3-dimensional (3D) object (e.g. 3D model, 3D reality model, mesh, etc.). The process then generates 2-dimensional (2D) slices, i.e. cross-sections, of the 3D object at various elevations and angles. The relation between the slices is critical for identification. The 2D slices are used as building blocks for automatic recognition and identification and location (e.g. x,y,z+angle) of a real-world equipment mounted on the 3D object and identifying any anomaly in the equipment so that remedial action may be ordered, if needed.

### CROSS-REFERENCE TO RELATED APPLICATIONS

The present application claims the benefit of U.S. Provisional Application Ser. No. 63/233,047, filed on Aug. 13, 2021, specification of which is herein incorporated by reference for completeness of disclosure.

### BACKGROUND OF THE INVENTION

### Field of the Invention

Embodiments of the invention relates to the identification of objects in 3D reality models. More specifically, the invention relates using pattern recognition in 2D cross-sections of the models to identify and measure objects in 3D space.

### Description of the Related Art

Currently there exists centers for viewing and analyzing geographically registered 3D models of cellular towers (monopoles, self supports and guy wires). These 3D models, such as in FIG. 1, may be created by drones using photogrammetry, for example. The models are usually to scale. Recognizing tower components as well as their elevation (from base steel), dimensions and orientation is important for various applications. This approach can be easily extended to other industries and use-cases.

Elevation measurements are generally made from a defined base plane. The base plane serves as reference for the remainder of the cross sections. As an example, a power generation dam may use the top of the dam as a base plane if this technique were applied to that industry. The base plane is defined by the bottom metal of the tower, for example. This manual process of defining the base plane only takes seconds. In addition, the center or axis of the tower can easily be defined at the same time. For example, FIG. 2 shows a screen shot of the tower 100 with the base plane 110 identified using an existing application for viewing and analyzing 3D reality models of cellular towers. The time-consuming part is outlining, in three dimensions (3D), the tower-mounted equipment (TME), e.g. 120, and finding elevations of corresponding center lines of the TME, e.g. 120, from the base plane 110, dimensions of the TME, and orientation of the TME from north (where north is defined in the 3D model). TMEs include antennas, remote radios units, mount structures, dishes, etc.—they all have well-defined borders and a few model types. Mounting structures include common material such as pipe, tubular steel, plate steel, angle iron, as well as mechanical joints such as nuts, bolts, welded pieces, and more. Working with 3D models in a tree data structure can be complex—pattern matching/Machine Learning (“ML”) can be computationally expensive. Feature extraction from photos can be equally hard, even with location mappings between the 2D photos and the 3D objects. For example, Amazon's ML APIs (Application Programming Interfaces) are good at 2D image recognition, but are not optimized for searching 3D space for pattern matching—which means it is very expensive computationally and ultimately monetarily.

Existing search algorithms in 3D space, such as kd-trees, quad trees, etc. are designed to quickly dissect 2D and 3D space into sections for search and for collision detection—they are not optimized for 3D pattern recognition search.

A multi-resolution technique for processing 3D point clouds is described in “Efficient 3D object recognition using foveated point clouds” by Rafael Beserra Gomes, Bruno Marques Ferreira da Silva, Lourena Karin de Medeiros Rocha, Rafael Vidal Aroca, Luiz Carlos Pacheco Rodrigues Velho, Luiz Marcos Garcia Gongalves.

Manual tracing of mounts and volumetric tracing of equipment can take hours of time, e.g., creating bounding boxes, e.g. 302, around antennas using manual tools (see FIG. 3). Finding boundaries of compounds is slightly less challenging, but nonetheless time-consuming.

In other areas, the medical industry for example, scans using slices and then attempts to recognize 3D objects by placing the slices together into a 3D model. And 3D printers recreate real world objects by laying down slices.

To overcome the problems and limitations described above there is a need for reality modelling for automatic object recognition using cross-sections.

### BRIEF SUMMARY OF THE INVENTION

One or more embodiments of the invention are directed a reality-based model object recognition system using cross-sections. The process begins with locating a 3-Dimensional (3D) object, e.g. a cellular tower, and using photogrammetry, lidar, and other suitable sensor technique to generate a 3D mesh/reality model. The 3D model comprises 3D objects (with a skin/surface).

In one or more embodiments, one or more reference points in the 3D object are defined. The reference points could include, for example, a base metal, center of top and the bottom of the 3D model.

In one or more embodiments, a plurality of 2-Dimensional (2D) cross-sectional slices of the 3D model at various elevations are generated as reality outputs. The plurality of 2D slices at various angles are added to a library. The library grows as more identification of objects are made and as computer aided design (CAD) drawings of real-world objects are added to it. The library comprises 2D snapshots of CAD outputs of various real-world objects, the reality outputs, and/or original photographs of the 3D model. In one or more embodiments, the slicing axis may be changed for different regions of the 3D model to gain symmetry, for instance.

In one or more embodiments, one or more dense centers with critical components on the 3D model are identified and finer slices, i.e. slices close together, for example, may be taken 1.0 foot apart in one section of the model, and for closer slicing, the distance between slices may be reduced to about 0.5 inches or less at or proximate to the dense centers.

In one or more embodiments, pattern matching is used to identify the critical components using information in the library. Of course, the library builds up over time basically by learning, i.e. machine learning.

In one or more embodiments, each of the one or more mounted equipment on the 3D model are identified by correlating each identified critical component with a real-world standard objects.

In one or more embodiments, a report (e.g. comprising CAD drawing with meta-data) is generated for said 3D model comprising real-world identity of the one or more mounted equipment and their location on the 3D model.

In one or more embodiments, identification of an equipment leads to recognizing any anomaly in the mounted equipment and ordering remedial action. For example, an antenna bounding box may be identified using the slicing technique and the bounding box is determined to be down-titled in relation to the base plane approximately 5 degrees, but the antenna should be down tilted 10 degrees—this would generate an automatic report that could be placed into a database, email or both notifying stakeholders.

### BRIEF DESCRIPTION OF THE DRAWINGS

The above and other aspects, features and advantages of the invention will be more apparent from the following more particular description thereof, presented in conjunction with the following drawings wherein:

FIG. 1 is a 3D reality model of a cellular tower constructed of small polygons in 3D space.

FIG. 2 is a screen shot from the side showing identification of a base plane that lies directly on top of the base metal of the tower bottom mount, with all height measurements taken from the base plane.

FIG. 3 is another screenshot illustrating a bounding box manually drawn around a tower-mounted component.

FIG. 4 is a portion of the model showing a cellular tower.

FIG. 5 is a cross-sectional view of a tower in a model from directly above.

FIG. 6 is a 2D cross-section of a tower in the model taken in a horizontal plane, showing several pieces of TME wherein the TME is an antenna, in accordance with one or more embodiments of the present invention.

FIG. 7 is another 2D cross-section of the tower in the model taken in a different horizontal plane, again showing several pieces of TME in accordance with one or more embodiments of the present invention.

FIG. 8 is a mockup of a manual tool for defining the array representation of an object in accordance with one or more embodiments of the present invention.

FIG. 9 illustrates a computer and peripherals that when programmed as described herein may operate as a specially programmed computer capable of implementing one or more methods, apparatus and/or systems of the present invention.

FIG. 10 is a flow chart illustrating the methods of the reality-based object recognition using cross sections in accordance with one or more embodiments of the present invention.

### DETAILED DESCRIPTION

The present invention comprising reality model object recognition using cross-sections will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced items.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to”, “at least”, “greater than”, “less than”, and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth. The phrases “and ranges in between” can include ranges that fall in between the numerical value listed. For example, “1, 2, 3, 10, and ranges in between” can include 1-1, 1-3, 2-10, etc. Similarly, “1, 5, 10, 25, 50, 70, 95, or ranges including and or spanning the aforementioned values” can include 1, 5, 10, 1-5, 1-10, 10-25, 10-95, 1-70, etc.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

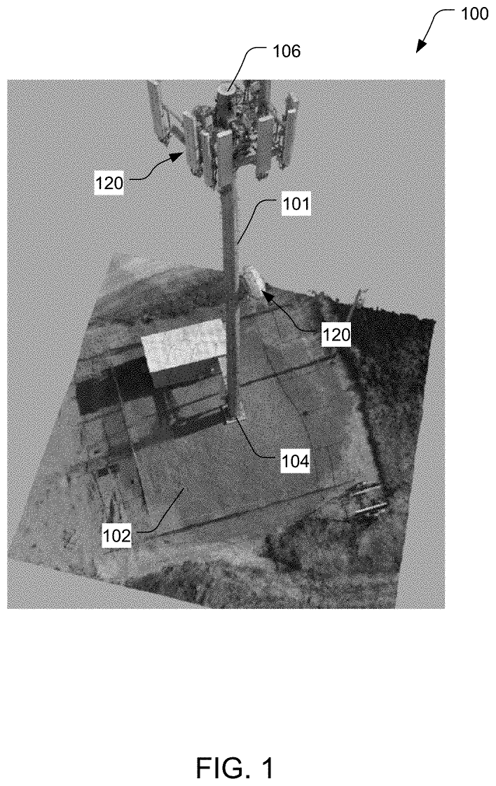

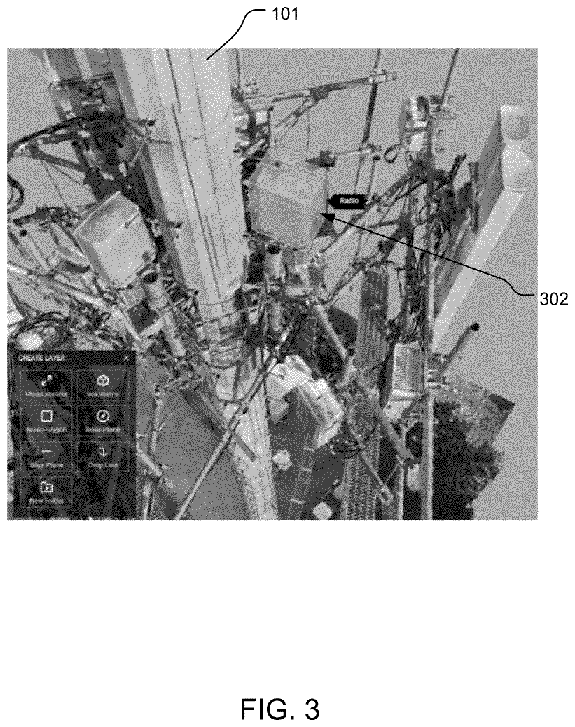

One or more embodiments of the present invention will now be described with references to FIGS. 1-10 using a metal tower for illustration. Note that although a metal tower is used herein, it is only for illustrative purposes only, and in no way is intended to limit the scope of the invention.

One or more embodiments of the present invention provides a system and method for automatic component recognition using machine learning (ML) and/or pattern recognition. The systems and methods presented herein are comprises using 2D cross-sections perpendicular to the axis of the tower pole, e.g. 101. Machine learning often relies on complex feature sets; by using stacks of 2D cross-sections and utilizing axis information, orientation, symmetry, and size. One or more embodiments, significantly reduces the dimensionality of the feature set for automatic component recognition.

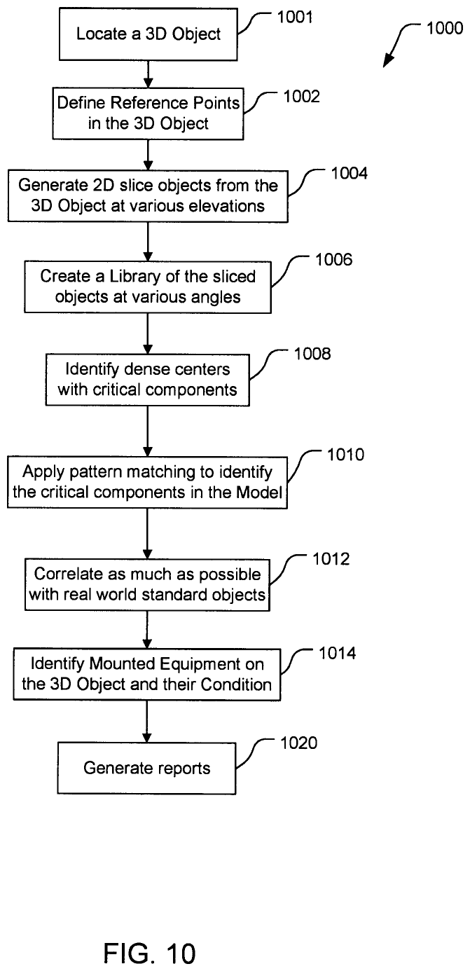

As illustrated in FIG. 10, one or more embodiments of the present invention uses an automated approach to finding 3D objects in reality models, identifying objects based ii on libraries that may be added to over time, measuring the objects, and labeling the objects. Ultimately, a report may be generated by analyzing the objects and the measurements.

One or more embodiments of the present invention uses photogrammetry to create the 3D object. Slices may be used for analysis and the characteristics of 2D stacked objects may be used to identify the 3D objects. The process 1000, as illustrated in FIG. 10, begins with locating a 3D object, e.g. a tower, in step 1001.

Pre-Conditions:

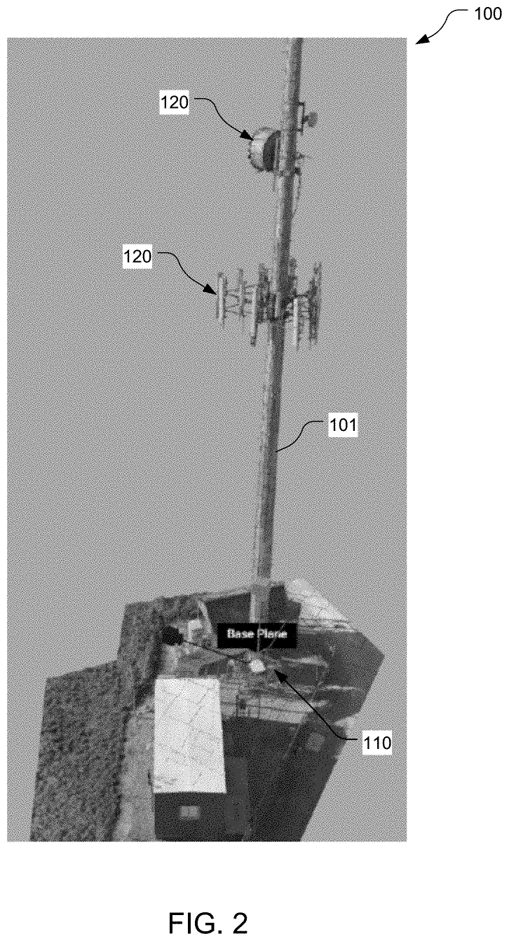

In step 1002, a user defines a few reference points in the object to aid with the process—e.g., the base metal 102, the center of top (e.g. 106) and the bottom of tower (e.g. 104), as illustrated in FIGS. 1 and 2. However, in some embodiments, the centers of the top and bottom may not be necessary. Either way, this should take only a few minutes. The marking of base metal and center of tower could be automated by using ML. The ML process of finding centers (e.g. of top and bottom) as a first step helps reduce the complexity of finding other objects.

User Interaction: (Reducing Dimensionality)

1) Define the reference (or base) plane and center of the tower: User clicks on three points on the surface of the base metal 102 in the model, or on other points that define the base plane 110 and thereby defining the base elevation. To find the center on a monopole, the user may click on a few opposing bolts, for example, to compute the center (similar on self supports). This process takes under 30 seconds to complete. In another exemplary use-case—a user for a power generation dam, the user clicks on the top of the dam to set a reference plane. In another use-case, for a power line or gas line, the user might rotate the base plane 90 degrees so it's orthogonal to the power line. By slicing a power line into sections orthogonal to the natural direction of the line, the algorithm could quickly identify the sag in the line. Sag is critical, because as lines carry more power the lines increase their sag, if the line touches a tree it could create a spark and ultimately a man-made fire.

2) Define top center of tower: User clicks on points around the top 106 of the tower to compute the center—approximately 30 seconds of user's time.

In one or more embodiments, both steps 1 and 2 above can be automated using Machine Learning.

Computer Automation:

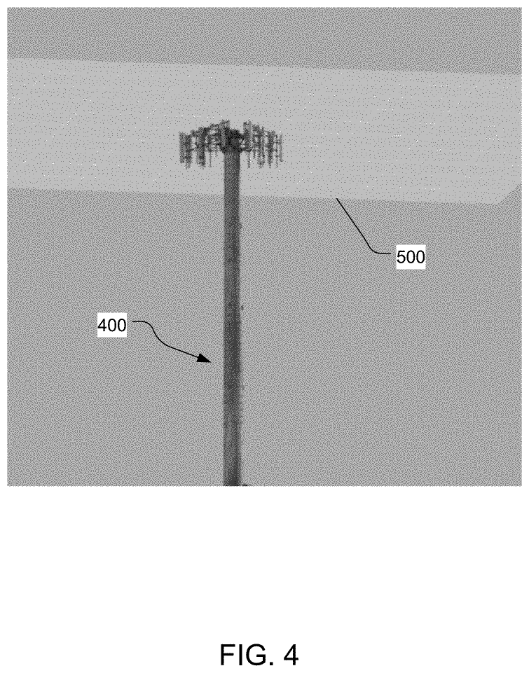

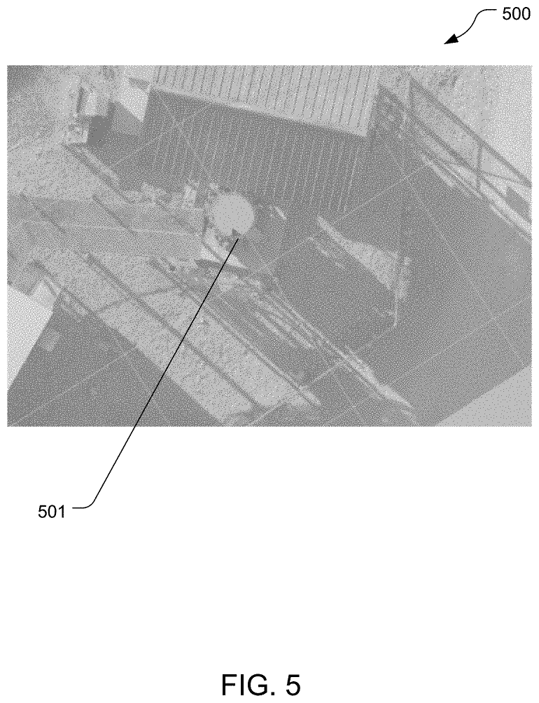

Having defined the base plane from which all measurements are made, an understanding of the x-y-z axis orientation of the tower is achieved, because of the marked center bottom and center top, and because in most instances, the tower is symmetric around the z-axis. FIG. 4 shows a tower 400, and FIG. 5 shows a horizontal cross-section 500 of the tower 400. In FIG. 5, the circular cross-section of the tower pole 501 can be seen from the slice.

The APIs for the 3D modeling system provides the capability to “slice” the 3D model—basically take a cross section of the model at any orientation, referred to herein as “z-slice”, in step 1004. The cross-section is a 2D drawing in the xy-plane extracted from the model and is parallel to the base plane. The cross-sectional method (z-slice) will only require a z axis value between 0 (base plane) and t representing the largest value in the z-axis direction valid for this 3D model in tree-space.

Algorithm:

In one or more embodiments, the algorithm picks an axis and slices up the model keeping track of the location of the 2D cross section slices relative to each other and to the reference plane. The algorithm decrements values from top of the model (z=t) to the base plane (z=0) every 1/16 inch delta interval, for example (in one or more embodiments, the delta should be chosen based on the desired accuracy resolution of the model). In other embodiments, the algorithm may start from the base, or use a different delta interval. In other embodiments still, a more efficient way may be to use a divide-and-conquer algorithm to identify where most of the tower equipment is located and concentrate the analysis in that section.

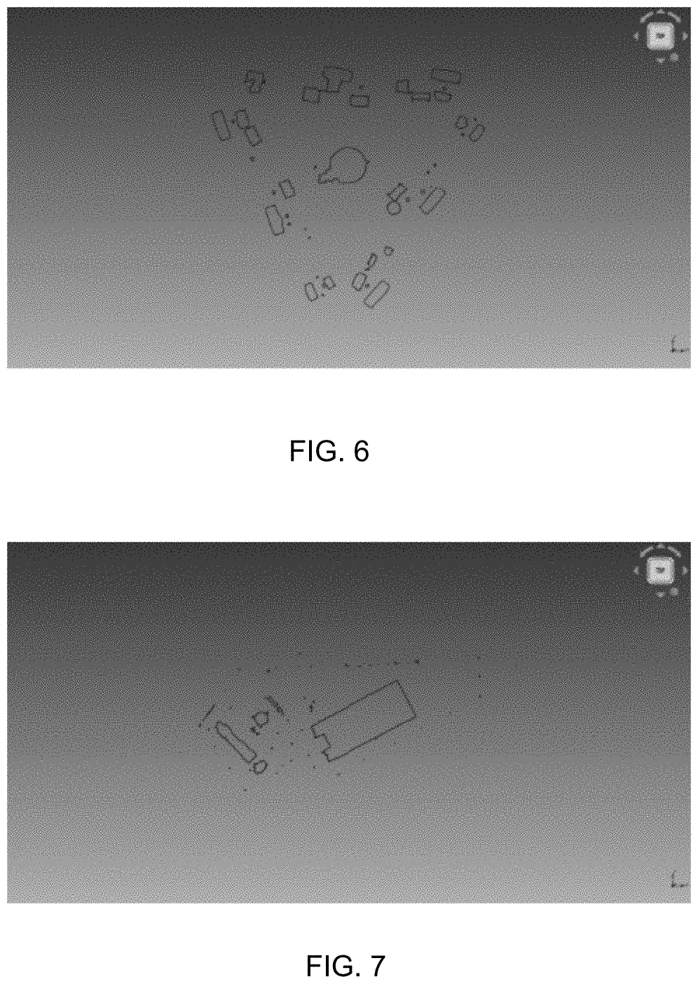

As the algorithm decrements, each 2D drawing (as illustrated in FIGS. 6 and 7), which could be a polyline export in DXF format, for example, is examined. First, the polylines are closed into entities representing a 2D slice of some object. Thus, libraries of sliced objects at various canted angles with mathematical descriptions and/or idealized shapes (created from CAD, i.e. computer aided design, models of objects) are generated, in step 1006. The library enhances the capability to deduce objects by their dimensions, locations, symmetry and size. In general, most cellular tower equipment (especially mounts) are symmetrical around the support. Each idealized object can have a characteristic matrix made of shapes, bounding sizes in x-y-z, common location, symmetry of the object as well as its position and elevation. Spatial relations between slices are critical to identifying and measuring objects. For example, finding I-shaped objects in a slice as the slices are stacked could indicate that the object is a piece of angled iron. And when the I-shaped objects no longer appear in the slices, it could indicate the end of the 3D object, i.e. the angled iron. When the end of the 3D object is located, the system may apply finer slices to the 3D model to more precisely find the bounding box.

Other applications may have similar symmetries, for example a bridge might be fairly symmetric around the roadway if a slice is taken along the length of the bridge. One of the primary goals of this approach is to identify objects as well as all the dimensional information and/or any physical characteristics (e.g. Object=11 gauge angle iron, coordinates of bounding box, dimensional information, material=galvanized soft steel). A exemplary output is 2D or 3D CAD models with potentially additional meta-data as described.

Using the divide-and-conquer approach the system can quickly understand where groups of objects are located on the model, e.g. in step 1008. In one or more embodiments, the system uses a simple heuristic approach which is based on the squared area of solids in a slice as well as on elevation. For example, a monopole tower with two radiation centers (antennas for cellular service with radio equipment is called a radiation center or “rad” center) could have clusters of equipment at the top and then again two thirds of the way down the tower. The remainder of the tower would be bare. The tower does not need to be sliced at a fine level in the regions where it is bare. Thus, the divide-and-conquer algorithm may be used to find the “dense” radiation center regions quickly, in order to generate the slices.

To aid in the pattern matching, i.e. step 1010, a look-ahead function is used that starts placing 2D objects from the slices in a stack that represents a 3D object. As the stack grows, confidence in the identity of the object and its location and elevation increases.

Data Structures:

Segment the 2D slices into an array of entities. The array includes bounding box data associated with each entity used to index into the next slice. If a similar entity is found in the next slice, assume that it should be placed into the array with its corresponding entity below. The algorithms use a heuristic for defining “similar”: e.g., between adjacent slices, such that corresponding points move in the x-y plane not more than a defined distance d.

Post Identification Algorithms:

After objects are identified in a model, decisions are made concerning those objects. For example, some objects will be correlated with real-world counterparts—e.g., 2-meter section of a schedule 40 pipe might have slightly different dimensions in the reality model, because the scanning and rendering process is not perfect, but in most cases it is good enough to safely make an assumption (step 1012). The assumption often includes a heuristic function that helps associate a reality model object with its real-world counterpart. Often, an assignment is made that corresponds to the closest real-world size to a piece of standard material (although custom sizes may be contemplated). If the reality model size is close to two different sizes, the safe assumption is to choose the least strong material, so as not to overestimate the strength of the object (this should be published as an assumption in the tool). The process of pattern matching to real-world objects is an important part of the system of one or more embodiments of the present invention, because it allows the mapping of the real world to the reality model.

However, sometimes the real-world object is too complex for a structural analysis. This is common when conducting Finite Element Analysis (FEA), for example. For instance, a joint—e.g., two U-bolts attached with nuts around a pipe to a piece of angle iron—can be visualized simply as a line connecting two pieces of material in a drawing. That simplification of the joint allows the FEA programs to model the interaction. The simplified joint needs metadata associated with the joint. For example, the joint might be classified as a slip joint, with a certain degree of freedom in one direction, with a certain amount of holding power. These types of assumptions can be defined in the system prior to identification and output of the idealized model to CAD.

Thus, embodiments of the present invention can recognize various types of joints, for example, and then convert each joint to a notation that an analysis program can digest. For instance, if the system recognizes the elements of a tower mount, it may want to keep the complexity of the basic materials, e.g. size, orientation, etc. However, the system can then elect to simplify joints between materials to reflect complex interactions in a simple manner. In addition, the system's interface approach includes raw photos that can be used to identify a joint and then the user can select from a series of types, or the classification algorithm in the system can make the best guess. In one or more embodiments, the assumptions and simplifications are provided.

Ultimately, as the library of TME is expanded, the algorithm of the present invention will identify all basic building blocks of a piece of infrastructure—e.g. pipes, angle iron, plate steel, grate steel, tubular square steel—whatever the construction material is. The system can also recognize mechanical joints and the algorithm can make a best guess on classification or can set up the system to always prompt the user to classify the joint, and then the system can learn from the classifications. The user interface of the present invention allows the user to see the photographs of the joints, for example, by simply clicking on each joint. This can be extended to several applications including oil and gas facilities (transfer stations), dams, bridges, in general any commercial infrastructure.

The classification of objects and joints can be a complete CAD model of a structure or a simplified CAD that has a “stick figure” tracing of the structure and a metadata file that shows 1) a material list where each line in the figure has a material associated with it, and 2) each joint has a joint type associated with it.

Reporting: having CAD representations of structural systems, the system can generate reports, e.g. in step 1020. If a user wants to see some of the antennas data, for example, represented as a snapshot of the CAD drawing from various angles as well as a table of data this can be easily accomplished automatically. For example, the system could create snapshots of an antenna from various angles and include a table of values that include critical information, like down tilt and roll. Because of the object recognition, the system can combine 2D snapshots of either the CAD output, the reality Output, or the original photographs combined with a table of data for that object or any combination of the aforementioned. This can be done for any structural feature. In one or more embodiments, the output of the system is a bunch of classified objects (e.g. with a bounding box around an antenna, the down tilt and type of material is known) and the objects' dimensions and their position in space. Those of skill in the art would appreciate that the output could likely be a 3D CAD model (i.e. an idealized version of the 3D objects) as well as meta-data (e.g. material, dimensional info, angles, etc.).

User Interface for Creating Identifying Information for Objects:

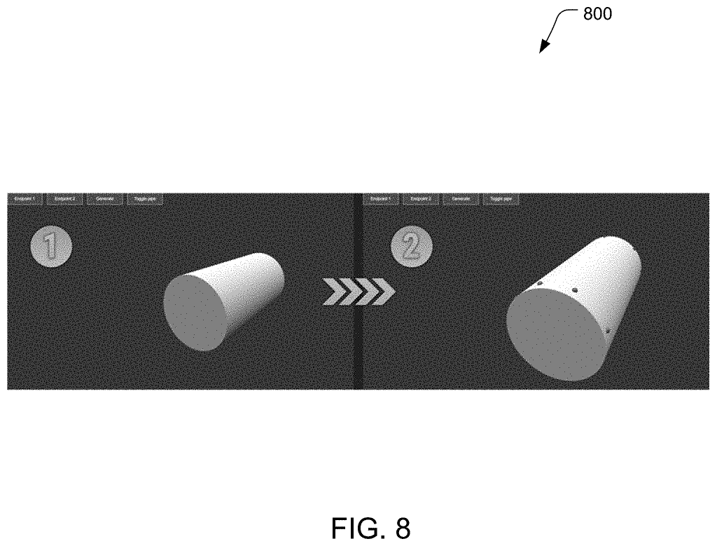

FIG. 8 is an illustration of a mockup of a graphical user interface for defining the object array. As illustrated, the user clicks on the outside of a tube 800 thus generating points that will later be used in a best fit algorithm (note this example shows a perfect tube, where a reality model will most likely have imperfections).

As an example, assume a 3D-model is loaded into a tool for viewing 3D models and the tube widget tool is selected. The tube widget helps identify tubes in the model. An array is presented to the user. The top row of the array has headings which indicate the types of points that the user is going to define. For example, the user might select “End-Point-1”, in which case the user should then select endpoints on only one side of the tube. As the user selects end points the user sees the end points on the 3D model, the user also sees the array (see Table 1 below) filling in with the values in 3D space. The user can select as many points as they want, but 3 or 4 should be enough. The user does the same for the other endpoint, by clicking on the array column for “End-Point-2”.

The user does the same for the outer surface of the tube, by clicking on the array heading “Outer” and then clicks on several points on the outside of the tube. Note, the user might have to adjust the 3D model as they are doing this process so they can access both sides of the tube. The user finally selects “Inner” and then clicks on sample points for the inner surface of the tube. The user may undo actions easily, or re-click on a point to erase it. After enough points have been selected, a button that says “generate” lights up. When the user clicks “generate”, an algorithm finds the best fit given the points for a tube. So, the algorithm “fits” a tube into the points generated. The interface shows the tube in a transparent color over the tube in the reality model, so the user can verify that the fit is good. The entire process should only take 30 seconds once the user is proficient.

Table 1 is an illustration of an Example Array generated with actual numbers from a 3D Model.

| End-Point-1 | End-Point-2 | Outer | Inner |
|---|---|---|---|
| {X: 0.1278285641659424 | {X: −0.04163558431312743 | {X: 0.039605991959007 | {X: 0.14141862148360052 |
| Y: 34.78545817923735 | Y: 32.35134696076324 | Y: 32.36398502879261 | Y: 34.77275813402589 |
| Z: 1.9663164253052674} | Z: 1.970904153545182} | Z: 1.901782254945338} | Z: 1.8706580994037383} |
| {X: 0.06794165790614473 | {X: 0.06273170300679404 | {X: 0.006739158100140 | {X: 0.07053595722420575 |
| Y: 34.78626342763173 | Y: 32.34873792139989 | Y: 32.41555569647917 | Y: 34.7815630951711 |
| Z: 1.9313607149331844} | Z: 1.961933151190709} | Z: 2.006386578168478} | Z: 1.8972808428149537} |
| {X: 0.10111721714089732 | {X: 0.045940882851885176 | {X: −0.03774238174434 | {X: 0.09092569277780944 |
| Y: 34.78434133409698 | Y: 32.35234257675896 | Y: 32.62044609835079 | Y: 34.7794654207335 |
| Z: 1.8600503602167673} | Z: 1.9102854236729963} | Z: 1.953806387555828} | Z: 1.9538863960588229} |
| | | {X: 0.085271093129701 | {X: 0.1587454475653659 |
| | | Y: 32.89811396468575 | Y: 34.77666474833089 |
| | | Z: 1.963472306401732} | Z: 1.9380196166039065} |
| | | {X: −0.0092742529753 | {X: 0.15063990860486848 |
| | | Y: 33.00782755141156 | Y: 34.777945040168206 |
| | | Z: 1.905060067513432} | Z: 1.877050848086275} |
| | | | {X: −0.032281333823559 |
| | | | Y: 32.34965616842498 |
| | | | Z: 1.9235331565116796} |

All of the data can then be used by a Machine Learning algorithm to help identify tubes automatically. This type of approach can be extended to other materials and even complex objects like radio antennas, electric power generation sub-station insulators, wires, or other structures.

Other Novel Approaches to Identifying objects in a 3D reality model

Machine Learning in 3D by using Projections

The z-slice approach to identifying objects in a 3D reality model might not be optimal for every structure. Given that we have a reality model, we by default have a virtual camera that defines our 2D view into the 3D model. For example, think of a monitor screen, it is flat, yet you perceive the 3D nature of what you are viewing. This is in part because the 3D to 2D projections are accurate. Since the projection is accurate your brain perceives it like you would the real world. In a 3D reality viewer, you can move or “fly” around in the model like in a video game. If you record the virtual flight you have a video. In the video, every frame can be precisely located in 3D space and you can also define the projection of every object in the frame. Thus, every frame you record is a 2D view of a 3D object where we can understand the 3D location by knowing the projection from 2D to 3D.

There currently exists in the prior art services for finding objects in a 2D picture or photo. These services can be trained by manually identifying objects in what is considered a “training set” of photos. Once the service is trained it can usually, with high precision, find objects in a new set of photos, e.g. a non-training set or novel set. One or more embodiments of the present invention utilizes this method of machine learning. For instance, the system trains a service to identify a Motorola antenna, for example, in a set of photos, the system then uses a novel set from the previously discussed flight in 3D space. Once the algorithm has found the antennas in a series of photos, the system uses the bounding box of the object to project from 2D space into 3D space. After several consecutive mappings from 2D to 3D, a bounding box in 3D space is generated.

Actions:

Once the TME is identified, e.g. step 1014, its condition may be assessed and it may be determined that it needs servicing, repositioning, upgrading or replacing. Such a determination may be based on its appearance from the 3D model, from a corresponding maintenance schedule or from corresponding purchase and installation records. A service technician may then be scheduled to visit the tower to carry out the necessary service, repositioning, upgrade or replacement. In other cases, the identification of the TME may be different to that which is recorded in the installation documents. If it is not clear from the image view within the model, then the system may prompt the dispatch of a drone to take closer-up photos or videos of the TME to help make the determination.

Other specific actions that can be taken for TMEs as a result of their identification include:

1) adjust antenna down tilt, roll, or azimuth position;

2) assess condition of the antenna's enclosure;

3) adjust or mend wiring from radio units to antennas or power wiring;

4) adjust or mend fiber optic bend radius;

5) adjust height above base steel;

6) assess condition of steel (rust, broken welds, deformations, construction not to specification, under-specified materials) and fix;

7) assess overloading of mounts and a) brace, or b) replace;

8) assess wind damage and deformation;

9) assess ice damage, lightening damage, etc.;

10) assess TMEs falling and damaging other TMEs or mounts;

11) assess buckling of materials;

12) assess guy wires, rubbing, position, sag, condition etc.

Specific actions for the main tower may include:

1) monopole, repairing deformation of side due to incorrect mount design or implementation;

2) remedying movement of tower outside of specification;

3) correcting leaning of tower;

4) complying with over-height requirement;

5) assessing fall zone issues (e.g. construction in fall zone) and taking safety measures. The fall zone is anywhere the tower can land if it falls over.

Other actions that may be taken that may be in relation to either the TME or the tower are the assessment of whether nuts are missing or backing off bolts, and either installing replacements or tightening them. There may also be missing washers or other hardware that can be replaced after assessing the structure. In some cases, incorrect angles may be identified between structural supports, either due to damage, slippage or an error in installation, all of which can be corrected as a result of the object recognition process. Inferior materials or incorrect thicknesses of materials, such as steel, may also be identified, and then replaced. Similar lists can be generated for other applications. For example, in the oil and gas industry a transfer station may be slices to identify pipes, supports, valves, manifold and tanks. Another example, a storage tank may be sliced along the vertical access creating rings associated with the outer surface, by examining those rings the system can identify deformations in the metal shell potentially finding dents, damages, or leaks.

Other Variations:

Slicing in one axis could be changed to multiple axes or even dynamically modified to create “sub” 3D models, where a volumetric area is extracted dynamically when sliced along one axis—then take an area along another axis and slice in an orthogonal direction to better and more quickly understand the 3D object.

Other ways of looking backwards and forwards through stacks of 2D images may be used for optimizing the process of identifying TME.

Different techniques may be used for determining where to cut the tower to obtain the 2D slices. For example, an antenna is mounted to a steel mount via bolts. The antennas and the mount are discrete objects. However, they look like one polygon when examining slices. The system may define different ways of cutting polygons based on their shape. Once again, this can be done with a heuristic function. However, another embodiment may use pattern matching. For instance, having a library, the system can match up the antenna after examining several slices. The system can then decide, e.g., that this is a “Motorola 791vr4”; based on the known shape of the antenna based on its specification, thus the system knows where to cut the antenna from its surrounding environment. In some embodiments, both methods are applied. Several heuristic functions may be necessary.

The 3D visualization engine may specify objects so they can be selected in the 3D visualization environment. For example, when the algorithm has found an antenna, a function/interface informs the 3D visualization engine where the object is located (i.e. by overlaying bounding box on the image).

In some embodiments, a library of cross-sectional features may be used, for example to help identify objects in the slice. In some cases, the cross-section of a piece of TME in a single slice may be sufficient to identify the TME.

Other Applications:

One or more embodiments of the present invention can be used for any object scanned using photogrammetry as long as the system can identify a meaningful axis for slicing the model. The axis may not be vertical, for example.

While the description has focused on structures for cellular communications, the present disclosure applies equally well to other situations or industries. For example, the system described may be used by power generation industries (for assessing sub-stations, lines, hydro, wind farms, nuclear, solar power generation and transmission equipment), for the oil and gas industries (e.g. oil rigs, including off-shore oil rigs in which the base plane may be defined as a deck with the z-axis values being negative as well as positive), for during and after construction of high rise buildings, bridges, piers, roller coasters, cranes, sail craft, etc.

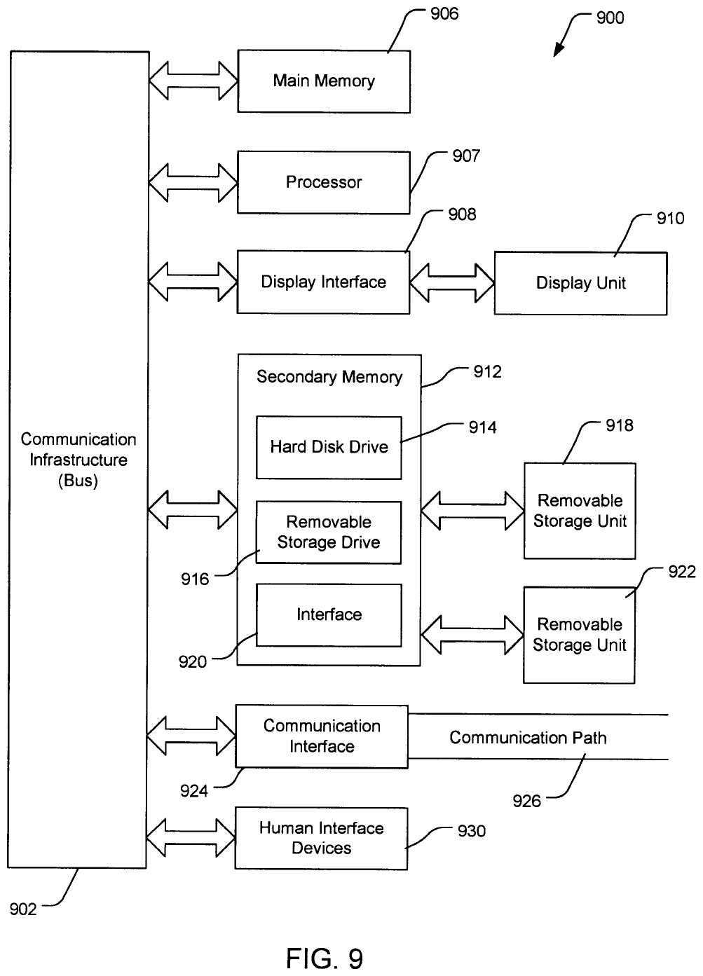

FIG. 9 is an illustration of a computer and peripherals, which when programmed as described herein, may operate as a specially programmed computer capable of implementing one or more methods, apparatus and/or systems of the solution described in this disclosure. Processor 907 may be coupled to bi-directional communication infrastructure 902 such as communication infrastructure system bus 902. Communication infrastructure 902 may generally be a system bus that provides an interface to the other components in the general-purpose computer system such as processor 907, main memory 906, display interface 908, secondary memory 912 and/or communication interface 924.

Main memory 906 may provide a computer readable medium for accessing and executing stored data and applications. Display interface 908 may communicate with display unit 910 that may be utilized to display outputs to the user of the specially-programmed computer system. Display unit 910 may comprise one or more monitors that may visually depict aspects of the computer program to the user. Main memory 906 and display interface 908 may be coupled to communication infrastructure 902, which may serve as the interface point to secondary memory 912 and communication interface 924. Secondary memory 912 may provide additional memory resources beyond main memory 906, and may generally function as a storage location for computer programs to be executed by processor 907. Either fixed or removable computer-readable media may serve as secondary memory 912. Secondary memory 912 may comprise, for example, hard disk 914 and removable storage drive 916 that may have an associated removable storage unit 918. There may be multiple sources of secondary memory 912 and systems implementing the solutions described in this disclosure may be configured as needed to support the data storage requirements of the user and the methods described herein. Secondary memory 912 may also comprise interface 920 that serves as an interface point to additional storage such as removable storage unit 922. Numerous types of data storage devices may serve as repositories for data utilized by the specially programmed computer system. For example, magnetic, optical or magnetic-optical storage systems, or any other available mass storage technology that provides a repository for digital information may be used.

Communication interface 924 may be coupled to communication infrastructure 902 and may serve as a conduit for data destined for or received from communication path 926. A network interface card (NIC) is an example of the type of device that once coupled to communication infrastructure 902 may provide a mechanism for transporting data to communication path 926. Computer networks such Local Area Networks (LAN), Wide Area Networks (WAN), Wireless networks, optical networks, distributed networks, the Internet or any combination thereof are some examples of the type of communication paths that may be utilized by the specially programmed computer system. Communication path 926 may comprise any type of telecommunication network or interconnection fabric that can transport data to and from communication interface 924.

To facilitate user interaction with the specially programmed computer system, one or more human interface devices (HID) 930 may be provided. Some examples of HIDs that enable users to input commands or data to the specially programmed computer may comprise a keyboard, mouse, touch screen devices, microphones or other audio interface devices, motion sensors or the like, as well as any other device able to accept any kind of human input and in turn communicate that input to processor 907 to trigger one or more responses from the specially programmed computer are within the scope of the system disclosed herein.

While FIG. 9 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resources are made available on demand over the Internet or any other network. In one or more embodiments, the system may also encompass parallel systems, multi-processor systems, multi-core processors, and/or any combination thereof. Where a virtual machine performs substantially similarly to that of a physical computer system, such a virtual platform will also fall within the scope of disclosure provided herein, notwithstanding the description herein of a physical system such as that in FIG. 9.

While the invention herein disclosed has been described by means of specific embodiments and applications thereof, numerous modifications and variations could be made thereto by those skilled in the art without departing from the scope of the invention set forth in the claims.

What is claimed is:

1. An object recognition method using reality-based modelling comprising:
locating a 3-Dimensional (3D) model generated by photogrammetry, lidar or other scanning techniques that generate 3D models including point clouds, meshes and reality models);
defining one or more reference points or planes in said 3D model;
generating outputs comprising a plurality of 2-Dimensional (2D) slices of the 3D model at various elevations;
adding said plurality of 2D slices at various angles to a library;
identifying one or more dense centers with critical components on the 3D model;
applying pattern matching to identify the critical components from said library;
identifying one or more pieces of equipment in said 3D model by correlating said identified one or more critical components with real world standard objects; and
generating a report of said 3D model comprising said one or more pieces of equipment.

2. The object recognition method of claim 1, wherein said one or more reference points comprises a base metal or some well-known reference point or plane, center of top and the bottom of said 3D object.

3. The object recognition method of claim 1, wherein said library comprises 2D cross section snapshots of computer aided design (CAD) outputs of various real-world objects, the reality outputs, and/or original photographs of said 3D model.

4. The object recognition method of claim 1, wherein said 3D model is a cellular tower or other piece of infrastructure.

5. The object recognition method of claim 1, wherein said report comprises real-world identity, dimensional information, material of said one or more mounted equipment and their location on said 3D model.

6. The object recognition method of claim 1, further comprising recognizing anomaly in at least one of said one or more mounted equipment and ordering remedial action.

7. The object recognition method of claim 1, wherein said photogrammetry, lidar scan, or other capture technique (or a combination of techniques) is performed by one or more drones.

8. A computer program product for reality-based object recognition, the computer program product comprising non-transitory computer-readable media encoded with instructions for execution by a processor to perform a method comprising:
locating a 3-Dimensional (3D) objects within a 3D model generated by photogrammetry or other scanning techniques such as lidar or combinations thereof;
defining one or more reference points in said 3D object;
generating a plurality of 2-Dimensional (2D) slices from within the 3D model at various elevations;
adding said plurality of 2D slices at various angles to a library identifying one or more dense centers with critical components on the 3D model;
applying pattern matching to identify the critical components from said library;
identifying one or more mounted equipment in said 3D model by correlating said identified one or more critical components with real-world standard objects; and
generating a report of said 3D model comprising said one or more pieces of equipment and spatial information using a CAD model.

9. The computer program product for reality-based object recognition of claim 8, wherein said one or more reference points comprises a base metal, center of top and the bottom of said 3D model. Spatial points or planes are dependent on the use-case and industry.

10. The computer program product for reality-based object recognition of claim 8, wherein said library comprises 2D snapshots of computer aided design (CAD) outputs of various real-world objects, the reality outputs, and/or original photographs of said 3D model.

11. The computer program product for reality-based object recognition of claim 8, wherein said 3D model is a cellular tower.

12. The computer program product for reality-based object recognition of claim 8, wherein said report comprises real-world identity of said one or more mounted equipment and their location (x, y, z) and angle on said 3D object and all dimensional information.

13. The computer program product for reality-based object recognition of claim 8, wherein said method further comprises recognizing anomaly in at least one of said one or more mounted equipment and ordering remedial action.

14. The computer program product for reality-based object/model recognition of claim 8, wherein said model is generated from photogrammetry, lidar, or combinations thereof performed by one or more drones.
